(19) United States
(12) Patent Application Publication
(10) Pub. No.: US 2008/0008097 A1
(43) Pub. Date: Jan. 10, 2008

(54) Methods and apparatus for providing measurement reports in a network environment

(76) Inventor: Phani Bhushan Avadhanam, San Diego, CA (US)

Correspondence Address: QUALCOMM INCORPORATED, 5775 MOREHOUSE DR., SAN DIEGO, CA, 92121, US

(21) Appl. No.: 11/484,246

(22) Filed: Jul. 10, 2006

(51) Int. Cl. H04J 1/16

(52) U.S. Cl. 370/235

(57) ABSTRACT

Methods and apparatus for providing measurement reports in a network environment. A method is provided that operates to provide a measurement report. The method includes receiving a report control message that comprises at least one parameter, measuring an error rate of a flow based on the at least parameter, generating a measurement report based on the error rate, and transmitting the measurement report. An apparatus is provided that operates to provide a measurement report. The apparatus includes receiving logic configured to receive a report control message that comprises at least one parameter, and error detection logic configured to measure an error rate of a flow based on the at least parameter. The apparatus also includes processing logic configured to generate a measurement report based on the error rate, and transmitting logic configured to transmit the measurement report.

### BACKGROUND

1. Field

The present application relates generally to the operation of communication systems, and more particularly, to methods and apparatus for providing measurement reports in a network environment.

2. Background

Data networks, such as wireless communication networks, have to trade off between services customized for a single terminal and services provided to a large number of terminals. For example, the distribution of multimedia content to a large number of resource limited portable devices (subscribers) is a complicated problem. Therefore, it is very important for network administrators, content retailers, and service providers to have a way to distribute content and/or other network services in a fast and efficient manner and in such a way as to increase bandwidth utilization and power efficiency.

In current content delivery/media distribution systems, real time and non real time services are delivered to devices on a network in one or more content flows. For example, a communication network may utilize Orthogonal Frequency Division Multiplexing (OFDM) to provide communications between a network server and one or more mobile devices. This technology provides a transmission frame having data slots that are packed with services to be delivered over a distribution network in the form of one or more content flows.

The performance of a communication system depends on the quality of reception, which can be expressed in terms of a Packet Error Rate (PER) or physical layer packet (PLP) error rate. For example, the PER can be used to indicate how accurately content flows transmitted over a network are able to be decoded by receiving devices. For example, a high PER indicates that a particular content flow is being received with many errors, which may result in degraded performance. Thus, it would be useful for network servers to know how accurately content flows are being received in order to determine the performance of the communication system and make adjustments if necessary.

Typically, network servers that deliver content flows over a distribution network are not aware of the PER being experienced at any particular receiving device. As a result, due to errors on the transmission channel, receiving devices may not able to accurately decode received content flows, however, the content servers may be unaware of the degraded performance.

Therefore is would be desirable to have a system that operates to provide error measurement reports in a communication system so that the performance of the system can be determined.

### SUMMARY

In one or more embodiments, a reporting system is provided that operates to provide measurement reports in a communication network. For example, the system is operable to report error rates experienced at devices in communication with the network. In an embodiment, the system utilizes a reporting control message to activate error measurements at one or more devices. Measurement logs are maintained at each device and when the error measurements are completed, the logs are transmitted to a network entity, such as a content server, so that network performance with respect to those devices can be evaluated and adjusted if necessary.

In an aspect, a method is provided that operates to provide a measurement report. The method comprises receiving a report control message that comprises at least one parameter, measuring an error rate of a flow based on the at least parameter, generating a measurement report based on the error rate, and transmitting the measurement report.

In another aspect, an apparatus is for provided that operates to provide a measurement report. The apparatus comprises receiving logic configured to receive a report control message that comprises at least one parameter, and error detection logic configured to measure an error rate of a flow based on the at least parameter. The apparatus also comprises processing logic configured to generate a measurement report based on the error rate, and transmitting logic configured to transmit the measurement report.

In another aspect, an apparatus is provided that operates to provide a measurement report. The apparatus comprises means for receiving a report control message that comprises at least one parameter, and means for measuring an error rate of a flow based on the at least parameter. The apparatus also comprises means for generating a measurement report based on the error rate, and means for transmitting the measurement report.

In another aspect, a computer-readable medium is provided that has a computer program which when executed operates to provide a measurement report. The computer program comprises instructions for receiving a report control message that comprises at least one parameter, instructions for measuring an error rate of a flow based on the at least parameter, instructions for generating a measurement report based on the error rate, and instructions for transmitting the measurement report.

In another aspect, at least one processor is provided that is configured to perform a method for providing a measurement report. The method comprises receiving a report control message that comprises at least one parameter, measuring an error rate of a flow based on the at least parameter, generating a measurement report based on the error rate, and transmitting the measurement report.

In another aspect, a method is provided that operates to provide a measurement report. The method comprises generating at least one report parameter, transmitting the at least one report parameter, and receiving a report message that identifies a PER associated with a selected content flow.

In another aspect, an apparatus is provided that operates to provide a measurement report. The apparatus comprises reporting logic configured to generate at least one report parameter, transmitting logic configured to transmit the at least one report parameter, and receiving logic configured to receive a report message that identifies a PER associated with a selected content flow.

In another aspect, an apparatus is provided that operates to provide a measurement report. The apparatus comprises means for generating at least one report parameter, means for transmitting the at least one report parameter, and means for receiving a report message that identifies a PER associated with a selected content flow.

In another aspect, a computer-readable medium is provided that has a computer program which when executed operates to provide a measurement report. The computer program comprises instructions for generating at least one report parameter, instructions for transmitting the at least one report parameter, and instructions for receiving a report message that identifies a PER associated with a selected content flow.

In still another aspect, at least one processor is provided that is configured to perform a method for providing a measurement report. The method comprises generating at least one report parameter, transmitting the at least one report parameter, and receiving a report message that identifies a PER associated with a selected content flow.

Other aspects of the embodiments will become apparent after review of the hereinafter set forth Brief Description of the Drawings, Description, and the Claims.

### BRIEF DESCRIPTION OF THE DRAWINGS

The foregoing aspects of the embodiments described herein will become more readily apparent by reference to the following detailed description when taken in conjunction with the accompanying drawings wherein:

FIG. 1 shows a network that comprises a reporting system;

FIG. 2 shows an embodiment of a reporting control message for use in a reporting system

FIG. 3 shows an embodiment of an error report message for use in a reporting system;

FIG. 4 shows an embodiment of measurement logic for use in a reporting system;

FIG. 5 shows an embodiment of a method for providing a reporting system;

FIG. 6 shows an embodiment of a method for providing a reporting system;

FIG. 7 shows an embodiment of a reporting system;

FIG. 8 shows an embodiment of control logic for use in a reporting system;

FIG. 9 shows an embodiment of a method for providing a reporting system; and

FIG. 10 shows an embodiment of a reporting system.

### DETAILED DESCRIPTION

In one or more embodiments, a reporting system is provided that operates to provide measurement reports in a communication network. For example, in an embodiment, the system utilizes a reporting control message to activate error measurements at a device. Error logs are maintained and returned to a network server so that the quality of transmissions experienced by the device can be determined. The system is especially well suited for use in wireless network environments, but may be used in any type of network environment, including but not limited to, communication networks, public networks, such as the Internet, private networks, such as virtual private networks (VPN), local area networks, wide area networks, long haul networks, or any other type of data network.

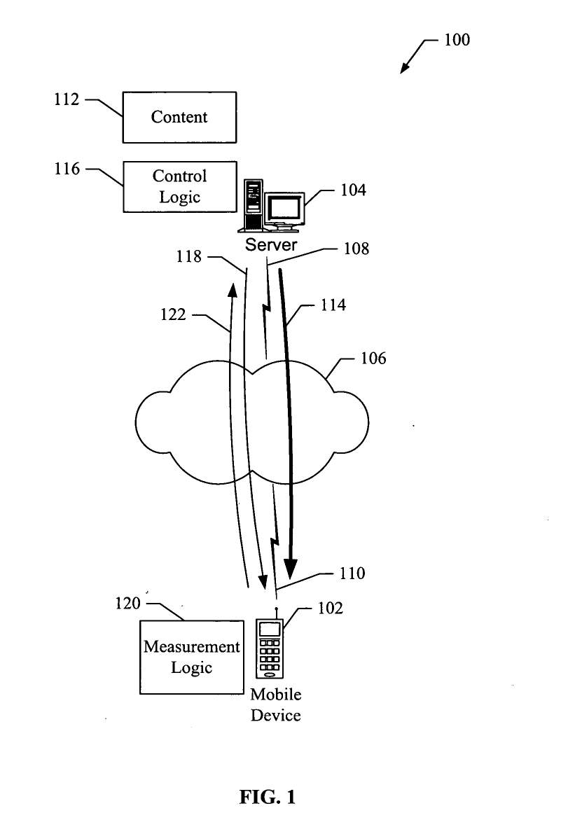

FIG. 1 shows a network 100 that comprises an embodiment of a reporting system. The network 100 comprises mobile device 102, server 104, and a communication network 106. For the purpose of this description, it is assumed that the network 106 operates to provide communications between the server 104 and one or more of the mobile devices using orthogonal frequency division multiplexing (OFDM) technology; however, embodiments of the reporting system are suitable for use with other transmission technologies as well.

In an embodiment, the server 104 operates to provide content and/or services that may be subscribed to by devices in communication with the network 106. The server 104 is coupled to the network 106 through the communication link 108. The communication link 108 comprises any suitable communication link, such as a wireless link based on OFDM technology that operates to allow the server 104 to communicate with the network 106. The network 106 comprises any combination of wired and/or wireless networks that allows content and/or services to be delivered from the server 104 to devices in communication with the network 106, such as the device 102.

The device 102 in this embodiment comprises a mobile telephone that communicates with the network 106 through the wireless link 110. In an embodiment, the wireless link 110 comprises a forward communication link based on OFDM technology and a reverse communication link based on any suitable reverse link technology. However, in other embodiments the wireless link 110 may comprise other suitable wired or wireless technologies that operate to allow devices to communicate with the network 106.

It should be noted that the network 106 may communicate with any number and/or types of devices within the scope of the embodiments. For example, other devices suitable for use in embodiments of the reporting system include, but are not limited to, a personal digital assistant (PDA), email device, pager, a notebook computer, mp3 player, video player, or a desktop computer.

The server 104 comprises content 112 that includes real time and non real time services. For example, the services comprise multimedia content that includes news, sports, weather, financial information, movies, and/or applications, programs, scripts, or any other type of suitable content or service. Thus, the content 112 may comprise video, audio or other information formatted in any suitable format.

The server 104 delivers the content 112 over the network 106 in one or more flows 114. For example, the flows 114 comprise audio, and/or video streams that may be received by devices in communication with the network 106.

The device 102 receives one or more of the flows 114 and decodes them to obtain audio and/or video information for presentation to the device user. If the quality of the network transmission channel is good, the flows 114 are received at the device 102 with few errors and the resulting presentations have desired quality levels. However, if the network transmission channel is degraded, the flows 114 will have errors that may result in unacceptable presentation quality levels. Thus, embodiments of the reporting system operate to allow the quality of the received flows to be determined and reported back to the server 104. The server 104 may then adjust one or more transmission parameters to compensate for the errors caused by a degraded transmission channel.

In an embodiment, the server 104 comprises reporting control logic 116 that operates to request that one or more devices report errors associated with one or more flows. For example, in an embodiment, the control logic 116 operates to transmit a reporting control message 118 to the device 102 requesting that the device 102 measure and report errors associated with one or more flows. In an embodiment, the message 118 is provided by a messaging service that operates to deliver messages from the server 104 to devices in communication with the network 106. In another embodiment, the message 118 (or its associated parameters) is encoded in a control channel that also provides information from the server 104 to devices in communication with the network 104. For example the messaging service allows messages to be sent to one or more selected devices, and the control channel allows messages to be sent to a group of devices that are listening on the control channel. In still another embodiment, the message 118 (or any of its parameters) is delivered to the device 102 in an out-of-band transmission or the parameters are pre-programmed into the device at an earlier time.

The device 102 comprises measurement logic 120 that receives the reporting control message 118 and activates a measurement process to measure the error rate of one or more flows based on parameters in the message 118. For example, the message 118 comprises a flow identifier, a start time, an end time, and reporting frequency parameters. The measurement logic 120 then measures and logs a packet error rate (PER) and/or any other error parameters associated with one or more of the flows 114. When the measurement is complete, the measurement logic 120 transmits one or more error logs back to the server 104 in an error report message 122. The server 104 may then adjust transmission parameters for one or more of the flows 114 based on the results provided in the error report message 122.

Therefore, embodiments of a reporting system operate to provide error reporting by performing one or more of the following functions.
a. A reporting control message is received at a device.
b. Error measurements are conducted on one or more flows based on parameters in the report control message.
c. An error log is generated.
d. The error log is transmitted to a server for analysis.

Therefore, embodiments of a reporting system operate to provide error measurement and reporting. It should be noted that the reporting system is not limited to the implementations described with reference to FIG. 1, and that other implementations are possible within the scope of the embodiments.

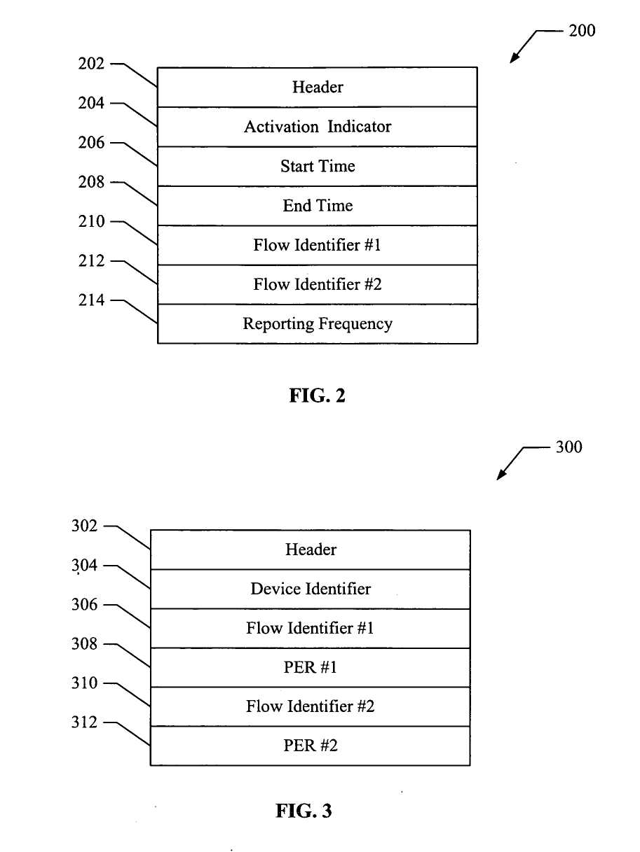

FIG. 2 shows an embodiment of a reporting control message 200 for use in a reporting system. For example, the reporting control message 200 is suitable for use as the reporting control message 118 shown in FIG. 1.

The reporting control message 200 comprises a header 202 that identifies the message as a reporting control message. The header 202 may comprises any suitable information in any suitable format to indicate that it represents the start of a reporting control message. After the header 202, the reporting control message 200 comprises an activation (or immediacy) indicator 204 that indicates whether the device is to enter the reporting mode immediately or at a designated future time (i.e., the next blackout period). The reporting control message 200 also comprises a start time indicator 206 that indicates a start time at which error measurements are to begin. The reporting control message 200 also comprises an end time indicator 208 that indicates an end time at which error measurements are to end.

The reporting control message 200 also comprises flow identifiers 210, 212 that identify flows for which error reporting is to occur. For example, the flow identifiers 210 and 212 may identify flows that are currently be transmitted from a server on a communication network. Any number or type of flows may be identified by the flow identifiers. The reporting control message 200 also comprises a report frequency indicator 214 that indicates a frequency at which error reporting is to occur. For example, the frequency indicator 214 may indicate time intervals in minutes, hours, days, etc. to indicate a frequency or rate at which error reporting for the identified flows is to occur.

It should be noted that the reporting control message 200 represents just one implementation and that other implementations are possible within the scope of the embodiments. For example, in other embodiments, the reporting control message 200 may comprise additions, deletions, changes, or modifications to the parameters shown.

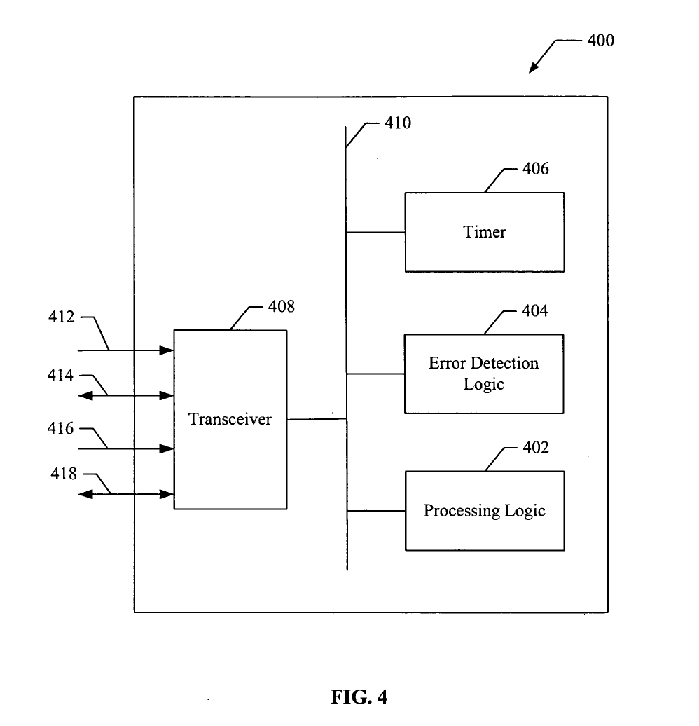

FIG. 3 shows an embodiment of an error report message 300 for use in a reporting system. For example, the error report message 300 is suitable for use as the error report message 122 shown in FIG. 1.

The error report message 300 comprises a header 302 that identifies the message as an error report message. The header 302 may comprises any suitable information in any suitable format to indicate that it represents the start of an error report message. The error report message 300 also comprises a device identifier 304 that identifies a device at which the error report message is generated. For example the device identifier may identify device 102 shown in FIG. 1.

The error report message 300 also comprises flow identifiers 306, 310 that identify flows for which error measurements have occurred. For example, the flow identifiers 306 and 310 may identify flows that are currently be transmitted from a server on a communication network. The error report message 300 also comprises PER 308, 310 that indicate a packet error rate for each of the flows 306, 310, respectively. A more detailed description of the generation of a PER is provided in another section of this document.

It should be noted that the error report message 300 represents just one implementation and that other implementations are possible within the scope of the embodiments. For example, in other embodiments, the message 300 may comprise additions, deletions, changes, or modifications to the parameters shown.

FIG. 4 shows an embodiment of measurement logic 400 for use in a reporting system. For example, the measurement logic 400 is suitable for use as the measurement logic 120 shown in FIG. 1. The measurement logic 400 comprises processing logic 402, error detection logic 404, timer 406, and transceiver 408 all coupled to a data bus 410.

The transceiver logic 408 comprises any suitable hardware and/or software that operate to allow the measurement logic 400 to communicate over a network. In an embodiment, the transceiver logic 408 comprises logic operable to receive one or more content flows over a communication link 412. For example, the communication link 412 may be a broadcast channel. The transceiver logic 408 also comprises messaging logic operable to send and receive messages over a messaging channel 414 using any suitable messaging service. The transceiver logic 408 also comprises control channel logic operable to receive information and/or parameters over a control channel 416. The transceiver logic 408 also comprises logic operable to send and receive messages over a unicast transmission channel 418. Thus, the transceiver logic 408 allows the measurement logic 400 to communicate with a network using many types of communication channels and technologies.

The processing logic 402 comprises a CPU, processor, gate array, hardware logic, virtual machine, software, and/or any combination of hardware and software. The processing logic 402 operates to process received reporting control messages to perform error measurement and report generation. For example, a reporting control message may be received by the transceiver 408 through the messaging channel 414 or the control channel 416. The reporting control message is then passed to the processing logic 402 for processing.

The error detection logic 404 comprises any suitable hardware and/or software that operates to perform error detection on one or more received flows. For example, the flows may be received from a network using the broadcast channel 412 provided by the transceiver 408. The error detection logic 404 operates to determine an error indicator for a selected flow over a given time interval by determining the number of PLPs that have been received with errors (bad PLPs) and the total number of PLPs received. The error indicator is determined by dividing the number of bad PLPs by the total received PLPs over the time interval.

The timer 406 comprises any suitable hardware and/or software that operates to measure a time interval during which error detection is performed. For example, the processing logic 402 controls the timer 406 to perform start, stop, reset, or any other timer functions. The timer 406 outputs one or more indicators to the processing logic 402 through the data bus 410 to indicate that a measured time interval has expired.

During operation, one or more flows are received through the transceiver logic 408 using the broadcast channel 412. A reporting control message is also received. For example, the reporting control message is received over the messaging channel 414 or the control channel 416. The reporting control message is passed to the processing logic 402 for processing. In an embodiment, the reporting control message is formatted as illustrated in FIG. 2. The reporting control message identifies one or more flows for which error rates are to be reported. The reporting control message also indicates a time interval and reporting frequency that are to be implementing in logging and reporting the error rates.

The processing logic 402 controls the timer 406 to measure the identified time interval. The processing logic 402 also controls the error detection logic 404 to measure a PER for the identified flows during the time interval. The results are logged by the processing logic 402 at the end of the time interval. The processing logic 402 then reports the logged results in a reporting message. For example, in an embodiment, the reporting message is formatted as illustrated in FIG. 3. The processing logic 402 transmits the reporting message to a network server using the transceiver logic 408 and unicast channel 418.

In an embodiment, the reporting system comprises a computer program having one or more program instructions (“instructions”) stored on a computer-readable medium, which when executed by at least one processor, provides the functions of the reporting system described herein. For example, instructions may be loaded into the measurement logic 400 from a computer-readable media, such as a floppy disk, CDROM, memory card, FLASH memory device, RAM, ROM, or any other type of memory device. In another embodiment, the instructions may be downloaded into the measurement logic 400 from an external device or network resource. The instructions, when executed by at least one processor at the measurement logic 400 operate to provide embodiments of a reporting system as described herein.

Thus, the measurement logic 400 operates to measure and report an error rate of one or more flows in a communication network. It should be noted that the measurement logic 400 is just one implementation and the other implementations are possible within the scope of the embodiments.

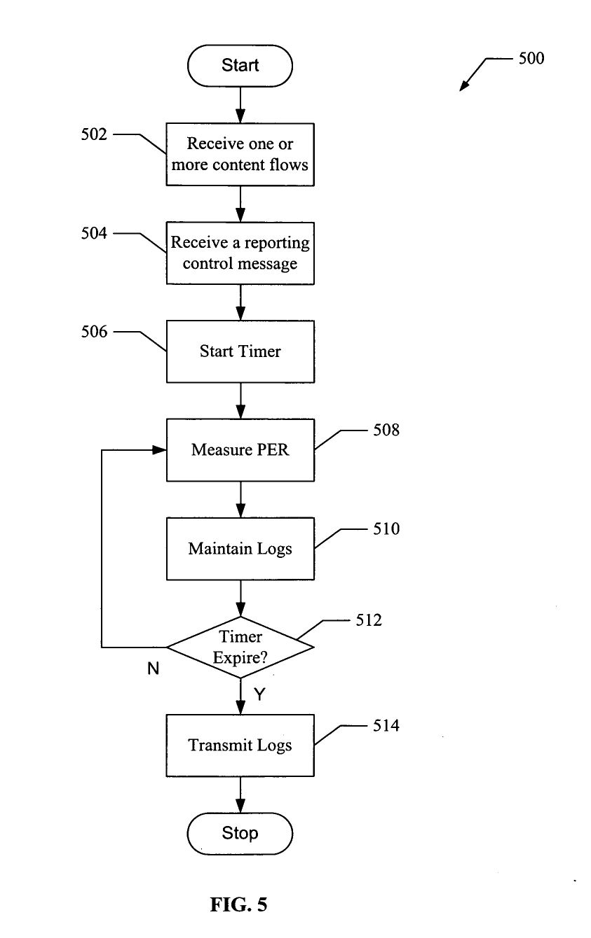

FIG. 5 shows an embodiment of a method 500 for providing a reporting system. For example, in an embodiment, the measurement logic 400 is configured to perform the method 500 as describe below.

At block 502, one or more flows are received. For example, one or more flows are received by the transceiver 408 over the broadcast channel 412. The flows may be passed to the processing logic 402 for rendering.

At block 504, a reporting control message is received. For example, the reporting control message is received by the transceiver logic 408 using the messaging channel 414 or the control channel 416. The reporting control message may also be received in an out of band transmission or preprogrammed into the device. In an embodiment, the reporting control message is formatted as shown in FIG. 2. For example, the reporting control message may comprise, but is not limited to, a header, activation indicator, start and end time indicators, flow identifiers, and reporting frequency indicator. The reporting control message is passed to the processing logic 402 for processing.

At block 506, a timer is started that starts a measurement time interval. The measurement time interval is a time interval during which error measurements of one or more flows are determined. In an embodiment, the processing logic 402 controls the timer 406 to start measuring the measurement time interval based on a start time indicator included in the reporting control message.

At block 508, a PER for one or more selected flows is determined. In an embodiment, the error detection logic 404 operates to measure the PER for one or more flows identified in the reporting control message. For example, the PER is based on the ratio of the number of bad PLPs to the total number of PLPs received.

At block 510, error logs are maintained. In an embodiment, the processing logic 402 communicates with the error detection logic 404 to received error indicators related to identified flows. The error indicators are processed into error logs that are maintained by the processing logic 402.

At block 512, a test is performed to determine if the measurement time interval has expired. In an embodiment, the timer 406 measures the measurement time interval, and when it expires, the timer 406 notifies the processing logic 402. If the timer has not expired, the method proceeds to block 508. If the timer has expired, the method proceeds to block 514.

At block 514, the error logs are transmitted. In an embodiment, the processing logic 402 operates to transmit the error logs to a network server using the transceiver logic 408 and communication channel 418.

Thus, the method 500 operates to provide an embodiment of a reporting system. It should be noted that the method 500 represents just one implementation and the changes, additions, deletions, combinations or other modifications of the method 500 are possible within the scope of the embodiments.

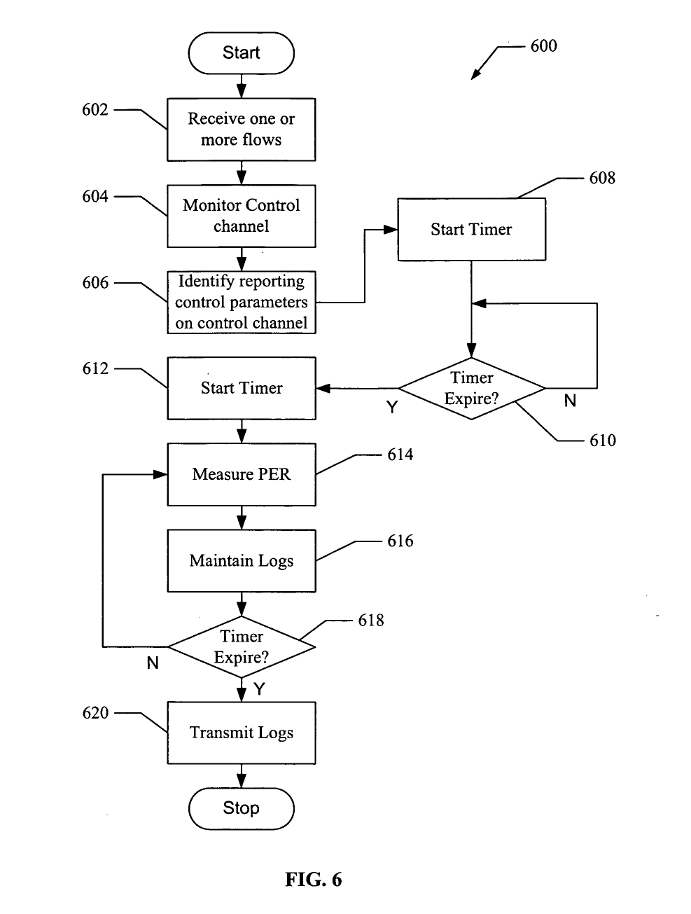

FIG. 6 shows an embodiment of a method 600 for providing a reporting system. For example, in an embodiment, the measurement logic 400 is configured to perform the method 600 as describe below.

At block 602, one or more flows are received. For example, one or more flows are received by the transceiver 408 over the broadcast channel 412. The flows may be passed to the processing logic 402 for rendering.

At block 604, a control channel is monitored. For example, the transceiver logic 408 monitors the control channel 416 for reporting control messages and/or parameters

At block 606, reporting control parameters are identified on the control channel. In an embodiment, the reporting control parameters may comprise, but are not limited to, a header, activation indicator, start and end time indicators, flow identifiers, and reporting frequency indicator. The reporting control parameters are passed to the processing logic 402 for processing.

At block 508, a timer is started that starts an activation time interval. The activation time interval is a time interval after which error measurements of one or more flows at determined. In an embodiment, the processing logic 402 controls the timer 406 to start measuring the activation time interval based on parameters received on the control channel 416.

At block 610, a test is performed to determine if the activation time interval has expired. In an embodiment, the timer 406 measures the activation time interval, and when it expires, the timer 406 notifies the processing logic 402. If the timer has not expired, the method waits at block 610. If the timer has expired, the method proceeds to block 612.

At block 612, a timer is started that starts a measurement time interval. The measurement time interval is a time interval during which error measurements of one or more flows at determined. In an embodiment, the processing logic 402 controls the timer 406 to start measuring the measurement time interval based on parameters received on the control channel 416.

At block 614, a PER for one or more selected flows is determined. In an embodiment, the error detection logic 404 operates to measure the PER for one or more flows identified by parameters received over the control channel. For example, the PER is based on the ratio of the number of PLPs received that have errors to the total number of PLPs received for a particular flow.

At block 616, error logs are maintained. In an embodiment, the processing logic 402 communicates with the error detection logic 404 to received error indicators related to identified flows. The error indicators are processed into error logs that are maintained by the processing logic 402.

At block 618, a test is performed to determine if the measurement time interval has expired. In an embodiment, the timer 406 measures the measurement time interval, and when it expires, the timer 406 notifies the processing logic 402. If the timer has not expired, the method proceeds to block 614. If the timer has expired, the method proceeds to block 620.

At block 620, the error logs are transmitted. In an embodiment, the processing logic 402 operates to transmit the error logs to a network server using the transceiver logic and communication channel 418.

Thus, the method 600 operates to provide an embodiment of a reporting system. It should be noted that the method 600 represents just one implementation and the changes, additions, deletions, combinations or other modifications of the method 600 are possible within the scope of the embodiments.

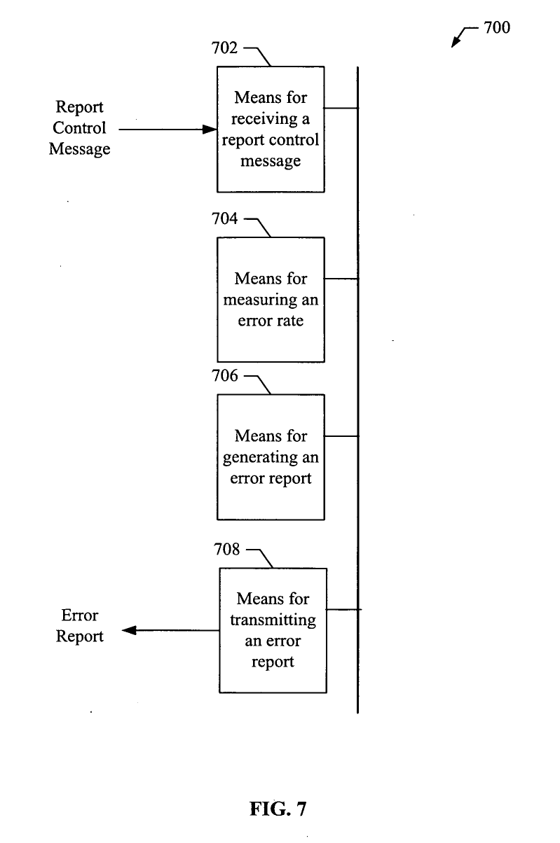

FIG. 7 shows an embodiment of a reporting system 700. The reporting system 700 comprises means (702) for receiving, which in an embodiment comprises receiving logic at the transceiver 408. The reporting system 700 also comprises means (704) for measuring, which in an embodiment comprises the error detection logic 404. The reporting system 700 also comprises means (706) for generating, which in an embodiment comprises the processing logic 402. The reporting system 700 also comprises means (708) for transmitting which in an embodiment comprises transmitting logic at the transceiver 408. In an embodiment, the means 702, 704, 706, and 708 are implemented by at least one processor configured to execute program instructions to provide embodiments of a reporting system as described herein.

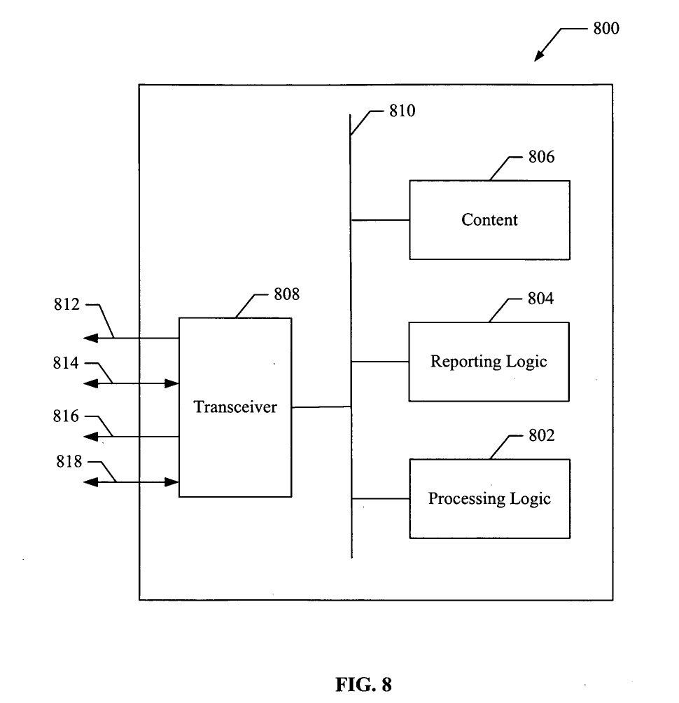

FIG. 8 shows an embodiment of control logic 800 for use in a reporting system. For example, the control logic 800 is suitable for use as the control logic 116 shown in FIG. 1. The control logic 800 comprises processing logic 802, reporting logic 804, content 806, and transceiver 808 all coupled to a data bus 810.

The content 806 comprises any suitable content that includes real time and non real time services. For example, the services comprise multimedia content that includes news, sports, weather, financial information, movies, and/or applications, programs, scripts, or any other type of suitable content or service. Thus, the content 806 may comprise video, audio or other information formatted in any suitable format.

The transceiver logic 808 comprises any suitable hardware and/or software that operate to allow the control logic 800 to communicate over a network. In an embodiment, the transceiver logic 808 comprises logic operable to transmit any or all of the content 806 in one or more content flows over a communication link 812. For example, the communication link 812 may be a broadcast channel over which one or more content flows are broadcast. The transceiver logic 808 also comprises messaging logic operable to send and receive messages over a messaging channel 814 using any suitable messaging service. The transceiver logic 808 also comprises control channel logic operable to send information and/or parameters over a control channel 816. The transceiver logic 808 also comprises logic operable to send and receive messages over a unicast transmission channel 818. Thus, the transceiver logic 808 allows the control logic 800 to communicate with a network using many types of communication channels and technologies.

The reporting logic 804 comprises any suitable hardware and/or software that operates to generate one or more reporting parameters that are transmitted to one or more devices. In an embodiment, the reporting logic 804 operates to select one or more devices that are to report back error indicators for one or more content flows. For example, the selected devices may be one or more individually identified devices or a group of devices that operate in the same geographic region. Virtually any selection technique can be used by the reporting logic 804 to select the devices that are to report back the error indicators. Additionally, any selection technique can be used to determine the flows for which error indicators are to be measured by the selected devices. For example, the flows may be identified by flow identifiers or by any other identification means. Thus, the reporting logic 804 operates to generate a report control message that includes reporting parameters which identify flows and measurement criteria.

In an embodiment, the messaging channel 818 is used to communicate a reporting control message to one or more selected devices. The reporting control message comprises the one or more reporting parameters. For example, the reporting control message may be formatted as shown in FIG. 2. In another embodiment, the control channel 816 is used to communicate the reporting parameters to devices listening to a network control channel. In another embodiment, the reporting parameters are transmitted to devices in an out-of-band communication.

During operation, the reporting parameters are incorporated into a reporting control message that is transmitted to one or more devices using the transceiver logic 808. For example, one or more content flows may be transmitted over a network using the broadcast channel 812 provided by the transceiver 808. The reporting logic 804 operates to selected one or more devices on the network that are to report error indicators for one or more of the content flows. A reporting control message is generated that identifies the flows and a time interval during which the error measurement are to be taken. The reporting control message is transmitted to the one or more devices using the transceiver logic 808 and the messaging channel 818. For example, an error indicator is determined for a selected flow over a given time interval by determining the number of PLPs that have been received with errors (bad PLPs) and the total number of PLPs received. The error indicator is determined by dividing the number of bad PLPs by the total received PLPs over the time interval.

The processing logic 802 comprises a CPU, processor, gate array, hardware logic, virtual machine, software, and/or any combination of hardware and software. The processing logic 802 operates to process received reporting messages to determine the performance of the network. In an embodiment, the reporting message is formatted as illustrated in FIG. 3. For example, a reporting message is received by the transceiver 808 through the messaging channel 818 or the unicast channel 816. The reporting message is then passed to the processing logic 802 for processing.

During operation, one or more reporting messages are received that comprise error indicators for selected flows broadcast over a network. In an embodiment, the processing logic 802 operates to process the received error indicators and determine whether the broadcast of the selected flows needs to be adjusted. For example, if the error rates reported are high, transmission parameters used by the transceiver 808 can be adjusted to incorporated additional error coding for the broadcasted flows. Virtually any type of adjustment of the performance of the system can be made by the processing logic 802 in response to the received error reports.

In an embodiment, the reporting system comprises a computer program having one or more program instructions (“instructions”) stored on a computer-readable medium, which when executed by at least one processor, provides the functions of the reporting system described herein. For example, instructions may be loaded into the control logic 800 from a computer-readable media, such as a floppy disk, CDROM, memory card, FLASH memory device, RAM, ROM, or any other type of memory device. In another embodiment, the instructions may be downloaded into the control logic 800 from an external device or network resource. The instructions, when executed by at least one processor at the control logic 800 operate to provide embodiments of a reporting system as described herein.

Thus, the control logic 800 operates to control which devices are activated to measure and report an error rate for one or more flows in a communication network. It should be noted that the control logic 800 is just one implementation and the other implementations are possible within the scope of the embodiments.

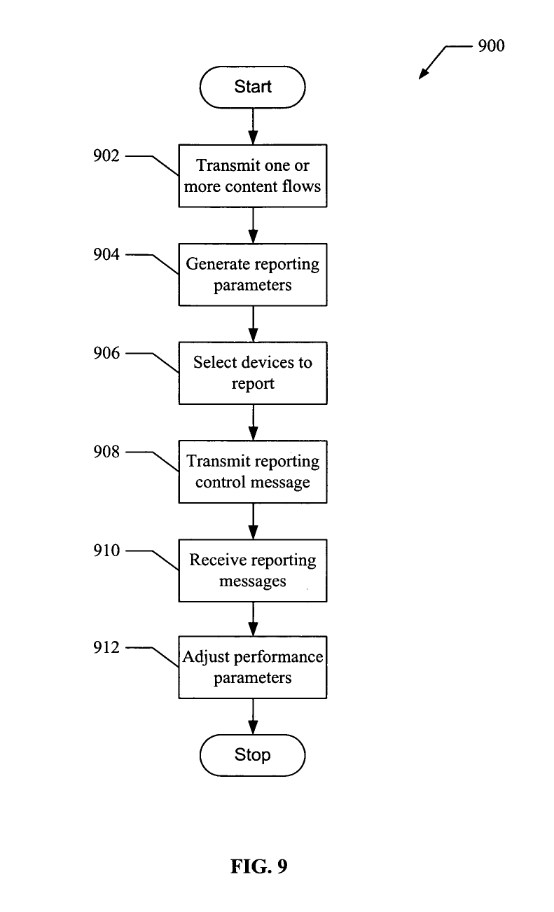

FIG. 9 shows an embodiment of a method 900 for providing a reporting system. For example, in an embodiment, the control logic 800 is configured to perform the method 900 as describe below.

At block 902, one or more content flows are transmitted. For example, one or more flows are transmitted by the transceiver 808 over the broadcast channel 812.

At block 904, reporting control parameters are generated. For example, the reporting control parameters are generated by the reporting logic 804. The reporting control parameters comprise flow identifiers and timing information that may be used by a receiving device to perform error detection. In an embodiment, the reporting control parameters are incorporated into a reporting control message.

At block 906, devices are selected to receive the reporting control parameters. For example, individual devices may be selected to receive the reporting control parameters or a group of devices may be selected. In an embodiment, the reporting logic 804 determines which devices are to receive the reporting control parameters.

At block 908, the reporting control parameters are transmitted by the transceiver logic 808. In an embodiment, the parameters are transmitted in a reporting control message using the messaging channel 814 or the control channel 816. The reporting control message may also be transmitted in an out-of-band transmission. In an embodiment, the reporting control message is formatted as shown in FIG. 2. For example, the reporting control message may comprise, but is not limited to, a header, activation indicator, start and end time indicators, flow identifiers, and reporting frequency indicator.

At block 910, the error logs are received in one or more error report messages. In an embodiment, the transceiver logic 808 operates to receive the error report messages from one or more devices on a network. For example, the report messages are received by the transceiver logic 808 using the messaging channel 814 or the unicast channel 818.

At block 912, the performance parameters are adjusted based on the error logs received in the report messages. For example, the processing logic 802 operates to process the error logs to determine if one or more transmission parameters need to be adjusted to compensate for high error rates. For example, the processing logic 802 may control the transceiver logic 808 to perform additional error coding on any flows associated with high error rates.

Thus, the method 900 operates to provide an embodiment of a reporting system. It should be noted that the method 900 represents just one implementation and the changes, additions, deletions, combinations or other modifications of the method 900 are possible within the scope of the embodiments.

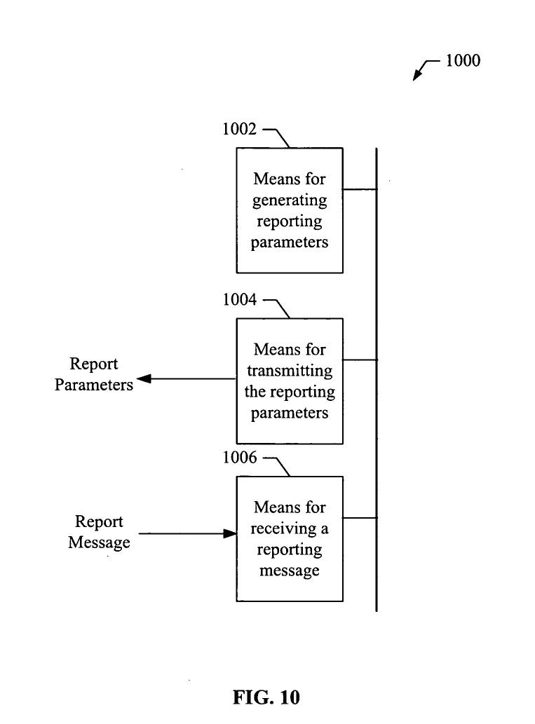

FIG. 10 shows an embodiment of a reporting system 1000. The reporting system 1000 comprises means (1002) for generating, which in an embodiment comprises the reporting logic 804. The reporting system 1000 also comprises means (1004) for transmitting, which in an embodiment comprises transmitting logic at the transceiver 808. The reporting system 1000 also comprises means (1006) for receiving, which in an embodiment comprises receiving logic at the transceiver 808. In an embodiment, the means 1002, 1004, and 1006 are implemented by at least one processor configured to execute program instructions to provide embodiments of a reporting system as described herein.

Therefore various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the processor, such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The description of the disclosed embodiments is provided to enable any person skilled in the art to make or use the present invention. Various modifications to these embodiments may be readily apparent to those skilled in the art, and the generic principles defined herein may be applied to other embodiments, e.g., in an instant messaging service or any general wireless data communication applications, without departing from the spirit or scope of the invention. Thus, the present invention is not intended to be limited to the embodiments shown herein but is to be accorded the widest scope consistent with the principles and novel features disclosed herein. The word “exemplary” is used exclusively herein to mean “serving as an example, instance, or illustration.” Any embodiment described herein as “exemplary” is not necessarily to be construed as preferred or advantageous over other embodiments.

Accordingly, while embodiments of a reporting system have been illustrated and described herein, it will be appreciated that various changes can be made to the embodiments without departing from their spirit or essential characteristics. Therefore, the disclosures and descriptions herein are intended to be illustrative, but not limiting, of the scope of the invention, which is set forth in the following claims.

What is claimed is:

1. A method for providing a measurement report, the method comprising:
receiving a report control message that comprises at least one parameter;
measuring an error rate of a flow based on the at least parameter;
generating a measurement report based on the error rate; and
transmitting the measurement report.

2. The method of claim 1, further comprising receiving the report control message using a messaging service.

3. The method of claim 1, further comprising receiving the report control message over a control channel.

4. The method of claim 1, further comprising receiving the report control message in an out-of-band transmission.

5. The method of claim 1, wherein said measuring comprising measuring a packet error rate (PER) of the flow.

6. The method of claim 5, further comprising determining the PER by dividing a bad packet indicator by a total packet indicator.

7. The method of claim 1, further comprising decoding the at least one parameter to determine one or more of a start time, end time, and frequency indicator.

8. The method of claim 1, further comprising decoding the at least one parameter to determine one or more flow identifiers.

9. Apparatus for providing a measurement report, the apparatus comprising:
receiving logic configured to receive a report control message that comprises at least one parameter;
error detection logic configured to measure an error rate of a flow based on the at least parameter;
processing logic configured to generate a measurement report based on the error rate; and
transmitting logic configured to transmit the measurement report.

10. The apparatus of claim 9, wherein said receiving logic is configured to receive the report control message using a messaging service.

11. The apparatus of claim 9, wherein said receiving logic is configured to receive the report control message over a control channel.

12. The apparatus of claim 9, wherein said receiving logic is configured to receive the report control message in an out-of-band transmission.

13. The apparatus of claim 9, wherein said error detection logic is configured to measure a packet error rate (PER) of the flow.

14. The apparatus of claim 13, wherein said error detection logic is configured measure the PER by dividing a bad packet indicator by a total packet indicator.

15. The apparatus of claim 9, wherein said receiving logic is configured to decode the at least one parameter to determine one or more of a start time, end time, and frequency indicator.

16. The apparatus of claim 9, wherein said receiving logic is configured to decode the at least one parameter to determine one or more flow identifiers.

17. Apparatus for providing a measurement report, the apparatus comprising:
means for receiving a report control message that comprises at least one parameter;
means for measuring an error rate of a flow based on the at least parameter;
means for generating a measurement report based on the error rate; and
means for transmitting the measurement report.

18. The apparatus of claim 17, further comprising means for receiving the report control message using a messaging service.

19. The apparatus of claim 17, further comprising means for receiving the report control message over a control channel.

20. The apparatus of claim 17, further comprising means for receiving the report control message in an out-of-band transmission.

21. The apparatus of claim 17, wherein said means for measuring comprises means for measuring a packet error rate (PER) of the flow.

22. The apparatus of claim 21, further comprising means for determining the PER by dividing a bad packet indicator by a total packet indicator.

23. The apparatus of claim 17, further comprising means for decoding the at least one parameter to determine one or more of a start time, end time, and frequency indicator.

24. The apparatus of claim 17, further comprising means for decoding the at least one parameter to determine one or more flow identifiers.

25. A computer-readable medium having a computer program which when executed operates to provide a measurement report, the computer program comprising:
instructions for receiving a report control message that comprises at least one parameter;
instructions for measuring an error rate of a flow based on the at least parameter;
instructions for generating a measurement report based on the error rate; and
instructions for transmitting the measurement report.

26. The computer program of claim 25, further comprising instructions for receiving the report control message using a messaging service.

27. The computer program of claim 25, further comprising instructions for receiving the report control message over a control channel.

28. The computer program of claim 25, further comprising instructions for receiving the report control message in an out-of-band transmission.

29. The computer program of claim 25, wherein said instructions for measuring comprise instructions for measuring a packet error rate (PER) of the flow.

30. The computer program of claim 29, further comprising instructions for determining the PER by dividing a bad packet indicator by a total packet indicator.

31. The computer program of claim 25, further comprising instructions for decoding the at least one parameter to determine one or more of a start time, end time, and frequency indicator.

32. The computer program of claim 25, further comprising instructions for decoding the at least one parameter to determine one or more flow identifiers.

33. At least one processor configured to perform a method for providing a measurement report, the method comprising:
receiving a report control message that comprises at least one parameter;
measuring an error rate of a flow based on the at least parameter;
generating a measurement report based on the error rate; and
transmitting the measurement report.

34. The method of claim 33, further comprising receiving the report control message using a messaging service.

35. The method of claim 33, further comprising receiving the report control message over a control channel.

36. The method of claim 33, further comprising receiving the report control message in an out-of-band transmission.

37. The method of claim 33, wherein said measuring comprising measuring a packet error rate (PER) of the flow.

38. The method of claim 37, further comprising determining the PER by dividing a bad packet indicator by a total packet indicator.

39. The method of claim 33, further comprising decoding the at least one parameter to determine one or more of a start time, end time, and frequency indicator.

40. The method of claim 33, further comprising decoding the at least one parameter to determine one or more flow identifiers.

41. A method for providing a measurement report, the method comprising:
generating at least one report parameter;
transmitting the at least one report parameter; and
receiving a report message that identifies a PER associated with a selected content flow.

42. The method of claim 41, further comprising adjusting one or more transmission parameters based on the report message.

43. The method of claim 41, further comprising transmitting the at least one report parameter using a messaging service.

44. The method of claim 41, further comprising transmitting the at least one report parameter over a control channel.

45. The method of claim 41, further comprising transmitting the at least one report parameter in an out-of-band transmission.

46. The method of claim 41, further comprising generating the at least one report parameter to comprise one or more of a start time, end time, and frequency indicator.

47. The method of claim 41, further comprising generating the at least one report parameter to comprise one or more flow identifiers.

48. Apparatus for providing a measurement report, the apparatus comprising:
reporting logic configured to generate at least one report parameter;
transmitting logic configured to transmit the at least one report parameter; and
receiving logic configured to receive a report message that identifies a PER associated with a selected content flow.

49. The apparatus of claim 48, further comprising processing logic configured to adjust one or more transmission parameters based on the report message.

50. The apparatus of claim 48, wherein said transmitting logic comprises logic configured to transmit the at least one report parameter using a messaging service.

51. The apparatus of claim 48, wherein said transmitting logic comprises logic configured to transmit the at least one report parameter over a control channel.

52. The apparatus of claim 48, wherein said transmitting logic comprises logic configured to transmit the at least one report parameter in an out-of-band transmission.

53. The apparatus of claim 48, wherein said reporting logic further comprises logic configured to generate the at least one report parameter to comprise one or more of a start time, end time, and frequency indicator.

54. The apparatus of claim 48, wherein said reporting logic further comprises logic configured to generate the at least one report parameter to comprise one or more flow identifiers.

55. Apparatus for providing a measurement report, the apparatus comprising:
means for generating at least one report parameter;
means for transmitting the at least one report parameter; and
means for receiving a report message that identifies a PER associated with a selected content flow.

56. The apparatus of claim 55, further comprising means for adjusting one or more transmission parameters based on the report message.

57. The apparatus of claim 55, further comprising means for transmitting the at least one report parameter using a messaging service.

58. The apparatus of claim 55, further comprising means for transmitting the at least one report parameter over a control channel.

59. The apparatus of claim 55, further comprising means for transmitting the at least one report parameter in an out-of-band transmission.

60. The apparatus of claim 55, further comprising means for generating the at least one report parameter to comprise one or more of a start time, end time, and frequency indicator.

61. The apparatus of claim 55, further comprising means for generating the at least one report parameter to comprise one or more flow identifiers.

62. A computer-readable medium having a computer program which when executed operates to provide a measurement report, the computer program comprising:
instructions for generating at least one report parameter;
instructions for transmitting the at least one report parameter; and
instructions for receiving a report message that identifies a PER associated with a selected content flow.

63. The computer program of claim 62, further comprising instructions for adjusting one or more transmission parameters based on the report message.

64. The computer program of claim 62, further comprising instructions for transmitting the at least one report parameter using a messaging service.

65. The computer program of claim 62, further comprising instructions for transmitting the at least one report parameter over a control channel.

66. The computer program of claim 62, further comprising instructions for transmitting the at least one report parameter in an out-of-band transmission.

67. The computer program of claim 62, further comprising instructions for generating the at least one report parameter to comprise one or more of a start time, end time, and frequency indicator.

68. The computer program of claim 62, further comprising instructions for generating the at least one report parameter to comprise one or more flow identifiers.

69. At least one processor configured to perform a method for providing a measurement report, the method comprising:
generating at least one report parameter;
transmitting the at least one report parameter; and
receiving a report message that identifies a PER associated with a selected content flow.

70. The method of claim 69, further comprising adjusting one or more transmission parameters based on the report message.

71. The method of claim 69, further comprising transmitting the at least one report parameter using a messaging service.

72. The method of claim 69, further comprising transmitting the at least one report parameter over a control channel.

73. The method of claim 69, further comprising transmitting the at least one report parameter in an out-of-band transmission.

74. The method of claim 69, further comprising generating the at least one report parameter to comprise one or more of a start time, end time, and frequency indicator.

75. The method of claim 69, further comprising generating the at least one report parameter to comprise one or more flow identifiers.
